(19) United States
(12) Patent Application Publication
(10) Pub. No.: US 2020/0275663 A1
(43) Pub. Date: Sep. 3, 2020

(54) Cleaning and Safe Mouth Guard Solution

(71) Applicants: Richard F. Stockel, Bridgewater, NJ (US); Bruce A. Nascimbeni, Hopewell, NJ (US); Dennis R. Hanlon, Naples, FL (US); John E. McCaskie, Princeton, NJ (US)

(72) Inventors: Richard F. Stockel, Bridgewater, NJ (US); Bruce A. Nascimbeni, Hopewell, NJ (US); Dennis R. Hanlon, Naples, FL (US); John E. McCaskie, Princeton, NJ (US)

(21) Appl. No.: 16/799,259

(22) Filed: Feb. 24, 2020

Related U.S. Application Data
(63) Continuation of application No. 16/445,404, filed on Jun. 19, 2019, now abandoned.
Application No. 16/445,404 is a continuation of application No. 13/987,732, filed on Aug. 26, 2013, now abandoned.

(51) Int. Cl. A01N 47/44; A01N 43/50; A01N 37/46

(52) U.S. Cl. CPC A01N 47/44; A63B 71/085; A01N 37/46; A01N 43/50

(57) ABSTRACT

An aqueous oral spray designed to treat mouth guards against bacterial infection comprising:
1. A naturally derived di-basic amino acid derivative,
2. A natural sweetener which inhibits the adhesion of bacteria to the oral cavity and,
3. Optionally a natural flavor and/or natural dye
4. Optionally a mouth guard surface modified to absorb specific components of above oral aqueous solution so as to render mouth guard more effective overtime in inhibiting microorganism growth on surface and in contact with mouth surfaces compared with unmodified mouth guard surface.

This application claims the benefit of provisional application for Ser. No. 61/743,615 field Sep. 7, 2012.

Mouth guards or mouth pieces are widely and it is probable that these devices can become easily contaminated with bacteria mold and yeasts during usage and cause a serious illness.

Mouth guards are commonly used in sport activities such as: baseball, football, basketball, martial arts, boxing, rugby, wrestling, hockey, water polo, skiing, snowboarding, lacrosse, skating, soccer, diving and a myriad number of other sport activities.

Mouth guards are also used for several oral, dental, and orthodontic applications:

1. Use as splints to reduce strain over the temporomandibular joint

2. Prevent tooth attrition in bruxism

3. Deliver topics medication

4. A night protector of thin porcelain bridges

5. Invisalign—a substitute for brackets and acrylic plates

6. Baby pacifiers and teething apparatus

Currently mouth guards are usually formed from thermoplastic polymeric materials such as among others, polyethylene, polypropylene, ethylene—vinyl acetate co-polymers (EVA), composites of low compression elastomer such as rubbers (polyisoprene, polybutadiene, polyisobutylene, polyurethanes) or vulcanized rubbers and layers of varying composition of EVA, styrene block copolymers (thermoplastic elastomers), etc. and molded in a variety of shapes, designs, thicknesses, and sizes.

A review of the literature on the subject of preventing infectious diseases from the misuse/handling of mouth guards suggests that the products on the market have severe limitations on their overall performance.

This invention teaches the use of very effective antimicrobial agents which are collectively known as di-basic amino acid derivatives. These are naturally derived compounds. As a sweetener in formulation, the invention utilizes xylitol which has claimed oral benefits.

Optionally, flavors and dyes can be added, for consumer acceptance but these are safe for health and naturally derived.

### PRIOR ART

The literature is replete with patents, articles and advertisements on mouth guards, and very little reference to methods to inhibit bacterial growth on the mouth guard surface or during normal use of mouth guard. Some patents claim antimicrobial substances incorporated into the polymer maxtrix and then extruding or forming the mouth guard. U.S. Pat. No. 4,537,689 discloses an oral lubricant formulation containing Parabens preservatives. See the abstract, column 5, line 48, and the six examples, where parabens are mentioned. Parabens are a well-known preservatives used in the cosmetic industry, however, they act as bacteriostatic agents, not bactericidal agents. All of the following patents—U.S. Pat. No. 6,257,239 B1, U.S. Pat. No. 6,581,604 B2, U.S. Pat. No. 6,691,710 B2, U.S. Pat. No. 7,328,706 B2, and U.S. Pat. No. 2,010,005/5233 are basically inventions concerning the mouth guard. They only use the term antimicrobial in the vaguest manner and there are no specific examples of antimicrobials given, no instructions on how this is accomplished, and most importantly, no experimental results are forthcoming. The problems involved in incorporating a biocide into a polymeric resin and then thermally heating it into a melt to achieve the desired shape. The antimicrobial agent must have the following properties:
1. Safe and non-toxic
2. Biodegradable
3. Quick and broad cidal activity against gram-positive and gram-negative bacteria, fungi, molds, yeasts, and viruses
4. If thermo formed into a mouth guard the antimicrobial compound must be thermally stable, since it will be subjected to high temperatures usually from 175° C. to about 225° C. for a period of time
5. If thermo formed the antimicrobial agent must diffuse (Fick's Law) at a rate to impede the growth of microorganisms.

The above criteria are very difficult to achieve. However, the claimed compositions of this invention, namely certain derivatives of di-basic amino acids, for example arginine, lysine, and hisitine have been found to excel for this application as a mouth guard spray/rinse.

Electronic searches found two commercial mouth guard sprays which were very similar to each other in composition and recommendations for use.
1. The product called “Grunge” spray contains 27% ethanol plus 3 essential oils, for example eucalyptol (900 ppm), Thymol, (490 ppm), and D-menthol (500 ppm) for a combined essential oil content of 1890 ppm or 0.189 weight percent.
2. Another commercial product contains even more ethanol (about 67%) and tea tree oil, a natural product which contains a variety of essential oils, antioxidants, and other components.

Other commercial aqueous mouth guards rinses/sprays, contain oral biocides commonly found in mouth washes. These oral biocides include:
1. Chlorhexidine gluconate (CHG) (0.12%),
2. Cetylpyryidinium chloride (0.045%) (CPC), domiphen bromide (0.005%). Both CPC and CHG are known to stain teeth and are not readily metalbolized in the body like the di-basic amino acid derivatives claimed in the current patent application, such as, LAE.HCl which is N^{α}-lauroyl-L-arginine-ethy ester-hydrochloride salt. The by products of CHG and CPC are not found naturally in the body as are the by products of LAE.HCl and/or its derivatives.

### THE INVENTION

It is obvious from the prior art than existing products disclosed in the literature have significant shortcomings, and fail to provide a safe, non-toxic, and efficacious solution to disinfect harmful bacteria which might causes serious bacterial infections for the user of this type of product.

This invention has overcome all of the problems and side reactions caused by the prior art disinfecting solutions by using di-basic amino acid derivatives, water, in place of substantial quantities of ethanol, a natural sweetener, and optionally natural flavors and/or dyes.

Specifically, the di-basic amino acids of this invention are a N^{α}-C8-C14 Alkanoyl-di-basic amino acid, C1 to C4, alkyl ester salts. The di-basic amino acid can comprise arginine, lysine or histidine, with arginine being preferred. The alkanoyl group can range from C8-C14, with C12 being preferred. The alkyl group can be from C1 to C4 with C2 being preferred. Salts can be chlorides, bromides, C1 to C5 saturated or unsaturated carboxylate anions, alpha or beta hydroxy carboxylate from C2 to C4. Other salts can be envisioned by one skilled in the art as long as the resulting salt has at least equal to or greater than 200 ppm solubility in the final formulation.

It should be emphasized that the product of this invention is free of any substantial alcohol. Upon biodegradation in the body approximately less than one ppm ethanol is released, which level can be easily metabolized without any toxic effects. In contrast, the two commercial products found in the literature (see above) have the potential to release much larger quantities of ethanol which can be problematic to one's human health perhaps causing alcoholic condition.

A second component of the formulation is the introduction of a natural sweetener, xylitol. Sweeteners are required because of consumer appeal for a favorable taste. While it does not have any antimicrobial advantage, it does contribute to an anti-adhering affect on bacteria to form bonding to teeth and oral mucosa particularly inhibiting biofilm formation. the suitable range of xylitol depends on the taste buds of the individual, but can range from about 1 to 5 weight percent. Even at low doses xylitol can favorably affect the bacterial composition of the oral cavity, Ref. “Science Daily”, Feb. 15, 2007 cites sugar substitute, xylitol, reduces risk of cavities.

Optionally, natural derived or natural identical flavoring substances obtained from plant or animal raw materials or by synthesis in the case of natural identified flavors can be added for organoleptic or other reasons. In either case it is preferred not to use artificial flavoring substances, although it is not prohibited from doing so. Natural flavors range from about 1 to 5 weight percent of the formulation.

Optionally, for aesthetic purposes, it is preferred to use only natural or natural identical dyes to impart an esthetically pleasing color to the aqueous formulation. Natural dyes maybe derived from animal, plant and minerals, (for example, Cochineal, LAC insects, indigofera plants, pomegranate peel, carbon and copper. Many other examples exist to choose from. Usage levels range from about 0.01 to about 0.10 weight percent of the total formulation.

A second part of the invention is the surface modified mouth guard itself which has been modified to be hydrophilic and specifically adsorb or react with the cationic active, etc., the active antibacterial agent in the above cited aqueous mouth guard rinse/spray formulation to render the antibacterial properties more long lasting under use conditions than would be the case with an unmodified mouth guard surface.

### SUMMARY OF ADVANTAGES OF THIS INVENTION

Many of the disinfecting mouth guard products found in commerce all contain from 27 to 67% ethanol. These products have more ethanol than commercial wine. These products can present the potential for alcohol abuse. In addition, ethanol has been cited as a health problem in recent medical journals:
1. Journal of Periodontology, 2004, Volume 72, (2) 333-334. “Mouthwashes (greater than or equal to 21% ethanol) cytotoxic effects on human gingival fibroblasts (cells) in vitro”
2. Biomed Pharmacother, March 2004, Volume 58, 84-89. “Influence of alcohol on antimicrobial immunity. Exposure to high levels of alcohol causes decreased humoral and cellular immune responses”

Also, the use of mouthwashes with high levels of ethanol tends to produce unpleasant side effects including pain and stinging of the oral mucosa with foul aftertaste.

The formulations of this invention have zero amount of ethanol, thus eliminating any negative effects in the human body causes by this chemical.

One of the commercial products that was analyzed not only contains a large amount of ethanol, but contains three essential biocidal oils. Specifically it contains 900 ppm of eucalyptol, 490 ppm of Thymol, and 500 ppm of D-menthol, for a total of 1890 ppm of total active constituents. In contrast our invention is N^{α}-lauroyl-L-arginine-ethyl ester hydrochloride, also known as LAE.HCl, which is used as a preservative in the food and cosmetic industries.
1. N^{α}-lauroyl-L-arginine-ethyl ester hydrochloride, (LAE.HCl) salt is naturally derived and metabolizes readily to L-arginine, an essential amino acid, lauric acid, and very low ppm amounts of ethanol. All degradation by products are found naturally in the body and are totally harmless.
2. LAE.HCl has undergone extensive toxicity, and safety studies, and it is approved by the FDA and EPA for food and cosmetic industries.
3. Microbiological tests using S. aureus as the pathogen shows that LAE.HCl at 200 ppm versus a product containing 27% ethanol and 1890 ppm of essential oils has comparable kill.
4. The formulation of our invention includes a natural sweetener xylitol. Xylitol is known to reduce cavities as well as inhibiting the adhesion of bacteria on enamel/dentin. The selection of xylitol has the above advantages over other natural or synthetic sweeteners. (“Science Daily”, Feb. 15, 2007)
5. Substantivity product of this invention has been proven experimentally versus the existing commercial products resulting in longer-lasting efficacy, using a zone of inhibition tests

### EXPERIMENTAL MICROBIOLOGICAL TESTS

1. Kill tests using S. aureus as the microorganism (SIK test) LAE.HCl at 600 ppm, xylitol at two weight percent, and a natural watermelon flavor at 0.25 weight percent gave a 99.9% to 99.99% kill in less than 1 minute.

Similar results were obtained for a commercial product examined. However, this product contained 1890 ppm (greater than three times the concentration of essential oils than the active ingredient used in this invention) plus 27% ethanol.

2. Substantivity tests on 100% cotton fabric using S. aureus as the microorganism/zone of inhibition (ZOI).

Both samples (600 ppm LAE.HCl and control) were applied to 100% cotton fabric at the same volumes and allowed to dry at room temperature. Samples were then placed in an agar plates inoculated with S. aureus and incubated. To these plates was added saliva from the same person to determine if either sample would produce a zone inhibition. A negative control was also run at the same time. Only the product of this invention gave a positive ZOI.

Surface modification of polymers to achieve hydrophilic, polar functional surface properties have been known for some years. Various methods and techniques have been employed to chemically modify the surface such as oxidation, sulfonation, amination, fluorination, etc. using immersion in chemicals as well as treatment of surface in the vapor/gas phase including ozonization, plasma activation, flame treatment, corona discharge, etc. Review for modifying the surfaces of polymers can be found by Allan S. Hoffman in the Chinese Journal of Polymer Science, Volume 13, No. 3, pages 195-203, 1995, and by J. McCaskie in Metal Finishing, 104(5) p. 33-35, 37-39, 2006. These references in their entirety are incorporated into this application.

### Example of Surface Treatment of Mouth Guard

A polymeric mouth guard, Pro Youth, manufactured by Shock Doctor™ was treated with SO₃ (sulfur trioxide gas 15 weight % mixed with dry air in the vapor phase in a closed vessel) for 1.5 min. at 50° C. followed by neutralization within chamber by ammonia vapor and water rinse. Alternative treatment conditions can achieve the same functional results by decreasing the concentration of SO₃ vapor and increasing the contact time of exposure. In general, the concentration can vary from 1-15% SO₃ gas in dry air and the time can vary from 1-30 minutes duration. Treatment conditions for specific polymers are optimized by doing performance trials under various conditions. The above treatment example produced a surface on the mouth guard which was polar hydrophilic (water wettable surface). The degree of functional surface treatment can be determined quantitatively by XRF (X-Ray Fluorescence) measurements of Sulfur content using standards, or alternatively by XPS (X-ray photoelectron spectroscopy) or by contact angle measurements using controls for reference. This modified surface selectively adsorbed not only water, but the positively charged LAE.HCl example molecule of the dibasic amino acid cited as functional material in the above mouth guard rinse/spray formulation. The adsorption of the LAE.HCl was substantive as demonstrated by exposure to the formulated rinse, drying and placement in contact with inoculated agar plate to measure for antibacterial activity at the area of contact. Another sample of polymeric Pro Youth mouth guard, manufactured by Shock Doctor™ was not treated by sulfonation technique was also exposed to the formulated rinse, dried and placed in contact with inoculated agar plate to measure for antibacterial activity at the area of contact. The qualitative rating of antibacterial activity of the SO₃ treated mouth guard vs. the untreated mouth guard is shown in Table 1. Further evidence of durability of the surface treatment for selective adsorption of LAE.HCl is the observation of taking treated mouth guard above which has been exposed to LAE.HCl containing rinse and subjecting it to full automatic dishwasher cycle and then exposing the washed mouth guard after rinse with LAE.HCl containing solution to the inoculated agar plate to measure extent of antibacterial activity at the area of contact. After this treatment, the mouth guard remained biocidally active.

TABLE 1
Zone of Inhibition Testing (ZOI)
Measurements are made either from the edge of the test material
(useful if sizes of substrate are irregular) or entire diameter
for round discs in contact with innoculated agar plate.

| | ZOI- Table 1 |
|---|---|
| | Rating; in mm of |
| | clearing from sample edge |
| SO₃ treated mouth guard + LAE rinse | 4.5 |
| Untreated mouth guard + LAE rinse | 0.5 |

TABLE 2
Zone of Inhibition Testing (ZOI)
Measurements are an average of 3 observations of the samples
which has innoculated agar poured over the entire test substrate
and observed for antibacterial clearing.

| | |
|---|---|
| SO₃ treated mouth guard + LAE rinse | 1.7 |
| Untreated mouth guard + LAE rinse | 0 |
| SO₃ treated sample + dishwasher cycle + LAE rinse | 1.5 |

(ZOI testing as follows: mouthgard soaked in the solution 1 hr to 48 hr, then set out to drip dry, then placed on a agar overlay plate which has been seeded with the organism, the plate is incubated and the amount of clearing is measured qualitatively using 0-5 scale)

### Accelerated Staining Tests

The porous side of 4″×4″ ceramic tiles were treated with the following solution, and baked on in a convection oven at 250° F. Grading system 1 (low) to 10 (highest) control.

| | First Round | Second Round |
|---|---|---|
| Control (dw) | 0 | 0 |
| 0.12% CHG | 3 | 6 |
| 0.06% LAE•HCl | 0 | 1 |

This illustrates less staining then CHG (chlorhexadine gluconate)

### Preservation Effectiveness Test Pet

This microbiological test is a measure of the robustness against contamination during use by the consumer and there by the safeness for the consumer is measured. In this test, (USP prescribed) bacteria are added to the product and then recovered after periods of room temperature storage. The test has a bacteria, a yeast and a mold and to pass you need 3 log reduction of the bacteria and 1 log reduction of the yeast/mold. In addition, there can be no increase of number of microorganism at later testing points for the duration of the test. This is a pass/fail test that is done on lab batches, aged batches and aged batches in final package.

PET Results (USP 51) FULLY FORMULATED
MOUTH GUARD RINSE

Log
Reduction

Day

| Organism | 2 | 7 | 14 | 28 |
|---|---|---|---|---|
| Pseudomonas. | 3 | 6 | 6.4 | 6.4 |
| Aeruginosa. (bacteria) | | | | |
| E. coli (bacteria) | 4.3 | 6 | 6.1 | 6.1 |
| Staphylococcus. | 5.5 | 6 | 6.1 | 6.1 |
| aureus(bacteria) | | | | |
| Candida | 3.6 | 4.8 | 4.8 | 4.8 |
| Albicans(yeast) | | | | |
| Aspergillus | n/a | 0 | 1.0 | 3.5 |
| Niger(mold) | | | | |

1. A mouth guard treating formulation comprising:
a. N^{α}-alkanoyl (C8-C14)-di-basic amino acid alkyl (C1 to C4) ester salt
b. A natural sweetener, and
c. Optional natural flavor and/or natural dye
d. Optionally a mouth guard which is surface modified to enhance the cationic biocide sustainability

2. Di-basic amino acid derivatives as claimed in claim 1 wherein the amino acid consists of L-arginine, L-lysine or L-histidine or combinations thereof

3. A preferred di-basic amino acid derivative as described in claim 2 is LAE.HCl

4. An effective concentration of the di-basic amino acid derivatives as described in claim 2 of about 100 ppm to about 900 ppm of the total formulation.

5. A natural sweetener as described in claim 1 comprising xylitol from about 1 to 5 weight percent of the total formulation.

6. Optionally as described in claim 1 a natural flavor can be added from 1 to about 5 weight percent of the total formulation.

7. Optionally as described in claim 1 a natural dye or synthetic equivalent may be added to the formulation at about 0.05 to about 2.0 weight percent of the total formulation.

8. A surface modified mouth guard which has been modified to be hydrophilic and specifically adsorb the active antibacterial agent as in claim 1 above aqueous mouth guard rinse/spray formulation to render the antibacterial properties more long lasting under use conditions than would be the case with an unmodified mouth guard surface.

9. A method to reduce the bacterial count on worn, used mouth guards by dipping, spraying or pouring inventive solution into or onto the mouth guard surface as described in claim 1 for a period of time and then ceasing contact with solution.

10. A method to surface modify a mouth guard as described in claim 8, so that the efficacy of biocidal activity is prolonged during usage by ionic, polar, dipolar, Vander Wads bonding between said surface modified mouth guard and said cationic biocides.
